(19) United States
(12) Patent Application Publication
(10) Pub. No.: US 2008/0117225 A1
(43) Pub. Date: May 22, 2008

(54) System and Method for Geometric Image Annotation

(76) Inventors: Rainer Wegenkittl, Sankt Poelten (AT); Donald K. Dennison, Waterloo (CA); John J. Potwarka, Waterloo (CA); Lukas Mroz, Wien (AT); Armin Kanitsar, Wien (AT); Gunter Zeilinger, Wien (AT)

Correspondence Address: LEWIS, RICE & FINGERSH, LC;ATTN: BOX IP DEPT., 500 NORTH BROADWAY, SUITE 2000, ST LOUIS, MO, 63102, US

(21) Appl. No.: 11/562,396

(22) Filed: Nov. 21, 2006

(51) Int. Cl. G09G 5/00

(52) U.S. Cl. 345/581

(57) ABSTRACT

A system and method for geometrical annotation of geospatial patient image data. First, an image block having geospatial image data such as an image series is acquired. Then at least one geometric shape having associated annotation data is defined within the image block and at least one display plane is selected within the image block. The geospatial image data associated with the display planes is displayed. Finally, it is determined if the display planes intersect with the geometric shapes and for each display plane that intersects with a geometric shape, the annotation data associated with the geometric shapes being intersected by that display plane is displayed.

### FIELD

The embodiments described herein relate to image display systems and methods and more particularly to a system and method for annotating images.

### BACKGROUND

Commercially available image display systems in the medical field utilize various techniques to present visual representations of geospatial image data containing patient information to users such as medical practitioners. Geospatial image data is produced by diagnostic modalities such as Computed Tomography (CT), Magnetic Resonance Imagery (MRI), ultrasound, nuclear imaging and the like and is displayed as medical images on display terminals for review by medical practitioners at a medical treatment site. Medical practitioners use these medical images to review patient information to determine the presence or absence of a disease, damage to tissue or bone, and other medical conditions. In order for medical practitioners to properly analyze the image data in three dimensions, image data is typically presented in various multi-planar views, each having a particular planar orientation.

FIG. 1A illustrates a human subject 1 in the conventionally known standard anatomical position (SAP) that is utilized to provide uniformity to modality images. The SAP is defined wherein the subject 1 is standing upright, feet together pointing forward, palms forward with no arm bones crossed, arms at the subject's 1 sides, looking forward. According to convention, regardless of the actual orientation of an anatomical feature such as a bone or skeleton, all images are referred to as if the subject 1 is standing in the SAP.

By convention, various planes of reference are defined with respect to the SAP, namely a sagittal plane (FIG. 1B), a coronal (or frontal) plane (FIG. 1C), an axial (or transverse) plane (FIG. 1D) and oblique planes (FIG. 1E). As shown in FIG. 1B, the sagittal plane 2 divides the subject 1 into a right half 3 and a left half 4. FIG. 1C illustrates the coronal plane 5, also known as the frontal plane, which divides the subject 1 into an anterior half 6 and a posterior half 7. The coronal plane 5 is orthogonal with respect to the sagittal plane 2.

FIG. 1D illustrates several axial planes 8. As shown, the axial planes 8 have a horizontal planar orientation with respect to the surface the subject 1 is standing on, and slice through the subject 1 at any height. Axial planes 8 are orthogonal to both the sagittal planes 2 (FIG. 1B) and coronal planes 5 (FIG. 1C) It is also generally understood that, when the term axial plane 8 is used to refer to a particular organ or other structure, the axial plane 8 is orthogonal to the long axis of the organ or structure.

Finally, FIG. 1E illustrates several oblique planes 9, being any plane tilted with respect to one axis (such as the x-axis, y-axis or z-axis). More generally, any plane that is not an axial, sagittal or coronal plane, and is not an oblique plane, is referred to as a double-oblique plane.

When a medical practitioner is reviewing geospatial image data about a particular patient, various image series containing patient information are often provided in different planar views (such as sagittal, coronal and axial views), to allow the medical practitioner to better determine the presence or absence of a medical condition and have a better understanding of the three dimensional anatomical features of the patient.

### SUMMARY

The embodiments described herein provide in one aspect, a method of geometrical annotation, comprising:

(a) acquiring an image block having geospatial image data;

(b) defining, within the image block, at least one geometric shape having associated annotation data;

(c) selecting, within the image block at least one display plane;

(d) determining if the at least one display plane intersects with the at least one geometric shape;

(e) displaying geospatial image data associated with the at least one display plane; and

(f) for each display plane where (d) is true, displaying the annotation data associated with the at least one geometric shape being intersected by that display plane.

The embodiments described herein provide in another aspect, a geometric annotation system, comprising:
(a) a database for storing the image block, wherein the image block comprises geospatial image data;
(b) a geometric annotation module configured to:
   (i) define, within the image block, at least one geometric shape having associated annotation data,
   (ii) select, within the image block at least one display plane, and
   (iii) determine if the at least one display plane intersects with the at least one geometric shape; and
(c) at least one display being configured to display geospatial image data of the image block associated with the at least one display plane,
wherein the at least one display being further configured to display the annotation data associated with the at least one geometric shape for each display plane that intersects with the at least one geometric shape.

Further aspects and advantages of the embodiments described will appear from the following description taken together with the accompanying drawings.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIGS. 1A, 1B, 1C, 1D, and 1E are schematic diagrams illustrating the standard anatomical position and the planar orientation of the sagittal, coronal, axial and oblique planes, respectively within a human subject;

FIG. 2 is a block diagram of an exemplary embodiment of a geometric annotation system for providing geometric imaging annotations;

FIG. 3 is a schematic diagram of an image block for use with the geometric annotation system of FIG. 2;

FIG. 4 is a flowchart diagram illustrating a method of providing geometric imaging annotations using the geometric annotation system of FIG. 2;

FIG. 5 is a schematic diagram of a graphical user interface for providing geometric imaging annotations to an image series using the geometric annotation system of FIG. 2;

FIG. 6 is a schematic diagram illustrating a sagittal image of a spine receiving geometric annotations using the geometric annotation system of FIG. 2;

FIG. 7 is a schematic diagram illustrating a coronal image of the spine of FIG. 6;

FIG. 8 is a schematic diagram illustrating a close-up coronal image of the spine of FIG. 6;

FIG. 9 is a schematic diagram illustrating a three-dimensional rendering of the spine of FIG. 6; and

FIGS. 10A and 10B are schematic representations of a geometrical shape intersecting with various images in an image series.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

It will be appreciated that for simplicity and clarity of illustration, where considered appropriate, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), at least one input device, and at least one output device. For example and without limitation, the programmable computers may be a personal computer, laptop, personal data assistant, and cellular telephone. Program code is applied to input data to perform the functions described herein and generate output information. The output information is applied to one or more output devices, in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein. The inventive system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

According to embodiments as described in greater detail below, a geometric object, such as a sphere, cylinder or other shape, is defined within an image block comprising at least one image series providing three-dimensional geospatial image data about a patient. The geometric objects serve as representations of particular anatomical features of a patient, and are provided with annotation information that is displayed to a user whenever a particular geometric shape intersects with the viewing plane currently being displayed on a display screen.

In one embodiment, a plurality of spheres is used to approximate the three dimensional location of the vertebrae of a spine within in an image series containing spine image data of a patient. A user is prompted to select a series of vertebrae within a particular image series by selecting a plurality of reference points, called markup points, within images of the image series. The user places each markup point at a point proximate the center of each vertebrae, switching between various planar views and images within a particular image series to accurately position the markup points. A midpoint indicator is then defined, generally located halfway in between two successive markup points, and is used to approximate the center of a vertebral disc between two adjacent vertebrae. In some embodiments, the user is provided with the option of adjusting the location of the location of the vertebrae disc by moving the disc point between two adjacent vertebral points.

A geometric shape, in this embodiment a sphere, is associated with each markup point to represent the vertebrae. Other geometric shapes, such as cylinders, can be associated with the midpoint indicators to represent the inter-vertebral discs. In some embodiments, the sphere is defined at the center of each markup point, having a radius proportionate to the distance between the particular markup point and the closest midpoint indicator. In some embodiments, the sphere has a radius equal to 90% of the distance between a markup point and the closest midpoint indicator.

In some embodiments, the user is prompted to annotate particular anatomical features, such as a spine, according to a predetermined sequence For example, the user could be prompted to begin labeling a spine starting with the first thoracic vertebra (T1) and proceeding in sequence towards the lumbar vertebrae, moving from head to feet within a particular image series.

During the image annotation phase, or “markup mode”, the user is shown one or more images of a series of images within one annotation plane. The user can switch to a different image series having a different planar orientation, and can cycle through different images within a particular series to select the appropriate three-dimensional location within the image block where the geometric shape is to be defined.

After a particular anatomical feature such as a spine has been labeled, the user can exit “markup mode” and enter “display mode”. In the display mode, the user is able to navigate through the various series of images within the image block. As the user navigates through the image block, the system tracks the particular viewing plane or display plane being shown to the user. When the display plane intersects with a particular geometric shape located within the image block, the system interprets this as an indication that a particular anatomical feature is being displayed, and displays annotation information to the user that is associated with the geometric shape being intersected. The annotation information typically includes information about the particular anatomical feature being displayed. For example, the annotation information may provide a listing of all the vertebrae that are currently visible to a user on the display plane. Further information on embodiments are provided in greater detail below.

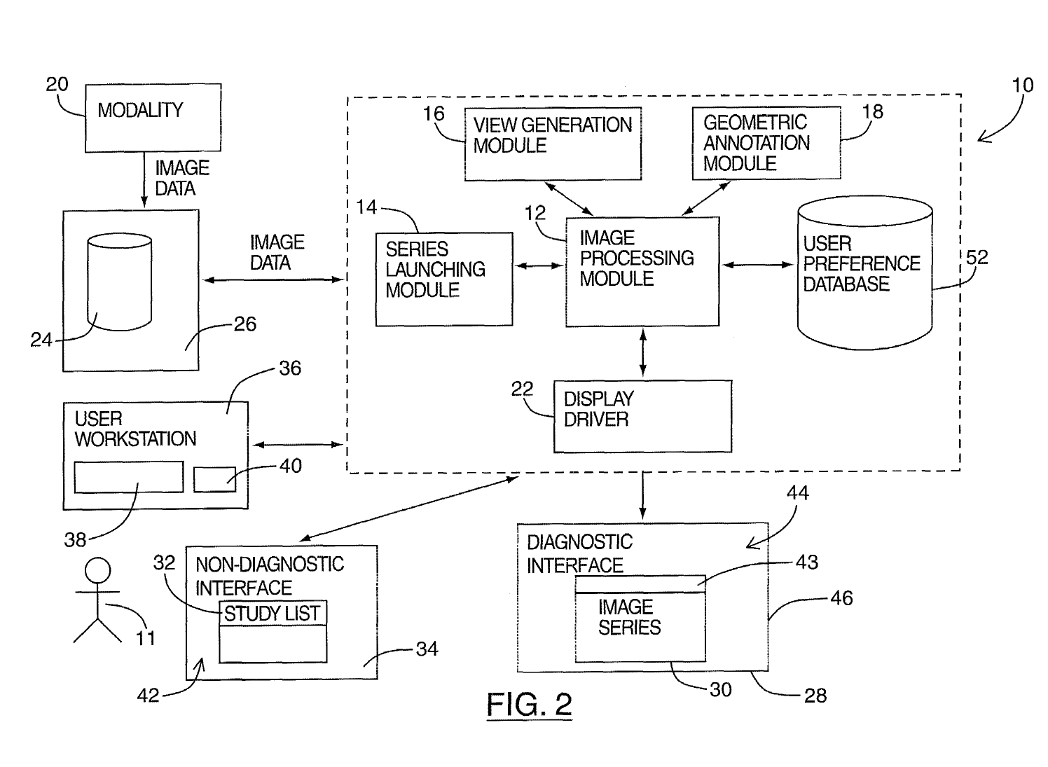

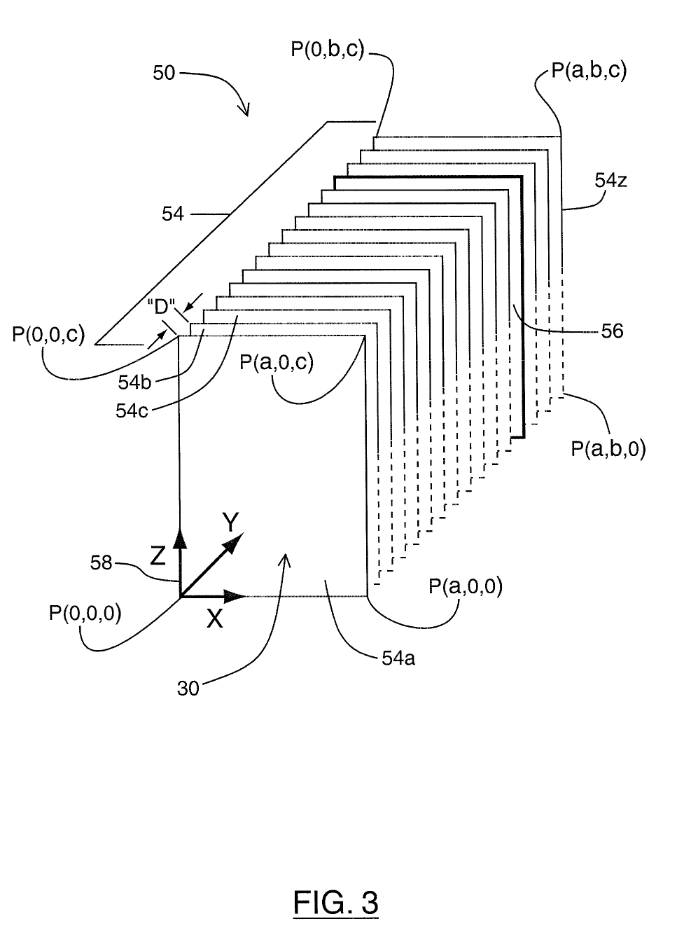

Turning now to FIG. 2, a geometric annotation system 10 is shown according to one embodiment, and includes an image processing module 12, a series launching module 14, a view generation module 16, a geometric annotation module 18 and a display driver 22. As shown, a block of geospatial image data has an associated image series 30 (i.e. a series of medical exam images in one planar orientation) generated by a modality 20 and stored in an image database 24 on an image server 26. The image server 26 allows the image data in a particular image block 50 (FIG. 3) to be retrieved and displayed on display interfaces, such as a diagnostic interface 28 and a non-diagnostic interface 34.

During operation, a user 11, usually a medical practitioner, selects or “launches” one or more of the image series 30 from a study list 32 on the non-diagnostic interface 34 using the series launching module 14. The series launching module 14 retrieves the geospatial image data within the image block 50 that corresponds to the image series 30 selected for viewing and provides it to the view generation module 16. The view generation module 16 then generates the image series 30 which is then displayed by the image processing module 12.

The user 11 typically interfaces with the image series 30 through a user workstation 36, which includes one or more input devices for example a keyboard 38 and a user-pointing device 40, such as a mouse or trackball. It should be understood that the user workstation 36 may be implemented by any wired or wireless personal computing device with input and display means, such as a conventional personal computer, a laptop computing device, a personal digital assistant (PDA), or a wireless communication device such as a smart phone. The user workstation 36 is operatively connected to both the non-diagnostic interface 34 and to the diagnostic interface 28. In some embodiments the diagnostic interface 28 and the non-diagnostic interface 34 are one single display screen.

As discussed in more detail above, it should be understood that the geometric annotation system 10 may be implemented in hardware or software or a combination of both. Specifically, the modules of the geometric annotation system 10 are preferably implemented in computer programs executing on programmable computers each comprising at least one processor, a data storage system and at least one input and at least one output device. Without limitation the programmable computers may be a mainframe computer, server, personal computer, laptop, personal data assistant or cellular telephone. In some embodiments, the geometric annotation system 10 is installed on the hard drive of the user workstation 36 and on the image server 26, such that the user workstation 36 operates with the image server 26 in a client-server configuration. In other embodiments, the geometric annotation system 10 can run from a single dedicated workstation that may be associated directly with a particular modality 20. In yet other embodiments, the geometric annotation system 10 can be configured to run remotely on the user workstation 36 while communication with the image server 36 occurs via a wide area network (WAN), such as through the Internet.

The non-diagnostic interface 34 typically displays the study list 32 to the user 11 within a text area 42. The study list 32 provides a textual format listing the various image series 30 within a particular image block 50 that are available for display. The study list 32 may also include associated identifying indicia, such as information about the body part or modality associated with a particular image series 30, and may organize the image series 30 into current and prior study categories. Other associated textual information (e.g. patient information, image resolution quality, date and location of image capture, etc.) can be displayed within the study list 32 to further assist the user 11 in selection of the particular image series 30 to be displayed. Typically, the user 11 will review the study list 32 and select a desired listed image series 30 to be displayed on the diagnostic interface 28.

The non-diagnostic interface 34 is preferably provided using a conventional color computer monitor (e.g. a color monitor with a resolution of 1024×768 pixels) driven by a processor having sufficient processing power to run a conventional operating system (e.g. Windows NT, XP, Vista, etc.). Since the non-diagnostic interface 34 is usually only displaying textual information to the user 11, high-resolution graphics are typically not necessary.

Conversely, the diagnostic interface 28 is configured to provide for high-resolution image display of the image series 30 to the user 11 within an image area 44. The image series 30 is displayed within a series box 46 that is defined within the image area 44 The series box 46 may also contain a series header 43 that contains one or more tool interfaces for configuration of the diagnostic interface 28 during use. The diagnostic interface 28 is preferably provided using medical imaging quality display monitors with relatively high-resolution as are typically used for viewing CT and other image studies, for example black and white or grayscale “reading” monitors with a resolution of 1280×1024 pixels and greater.

The display driver 22 is a conventional display screen driver implemented using commercially available hardware and software as is known in the art, and ensures that the image series 30 is displayed in a proper format on the diagnostic interface 28. The display driver 22 provides image data associated with the image series 30 formatted so that the image series 30 is properly displayed within one or more of the series boxes 46 and can be interpreted and manipulated by the user 11.

The modality 20 is any conventional image data generating device (e.g. computed tomography (CT) scanners, etc.) utilized to generate geospatial image data that corresponds to patient medical exams. A medical practitioner utilizes the image data generated by the modality 20 to make a medical diagnosis, such as investigating the presence or absence of a diseased part or an injury, or for ascertaining the characteristics of a particular diseased part, injury or other anatomical feature. The modalities 20 may be positioned in a single location or facility, such as a hospital, clinic or other medical facility, or may be remote from one another, and connected by some type of network such as a local area network (LAN) or WAN. The geospatial image data collected by the modality 20 is stored within the image database 24 on an image server 26, as is conventionally known.

The image processing module 12 coordinates the activities of the series launching module 14, the view generation module 16 and the geometric annotation module 18 in response to commands sent by the user 11 from the user workstation 36 and stored user display preferences from a user display preference database 52. When the user 11 launches an image series 30 from the study list 32 on the non-diagnostic interface 34, the image processing module 12 instructs the series launching module 14 to retrieve the image data that corresponds to the selected image series 30 and to provide it to the view generation module 16. The view generation module 16 then generates the image series 30, and the image series 30 is displayed by the image processing module 12.

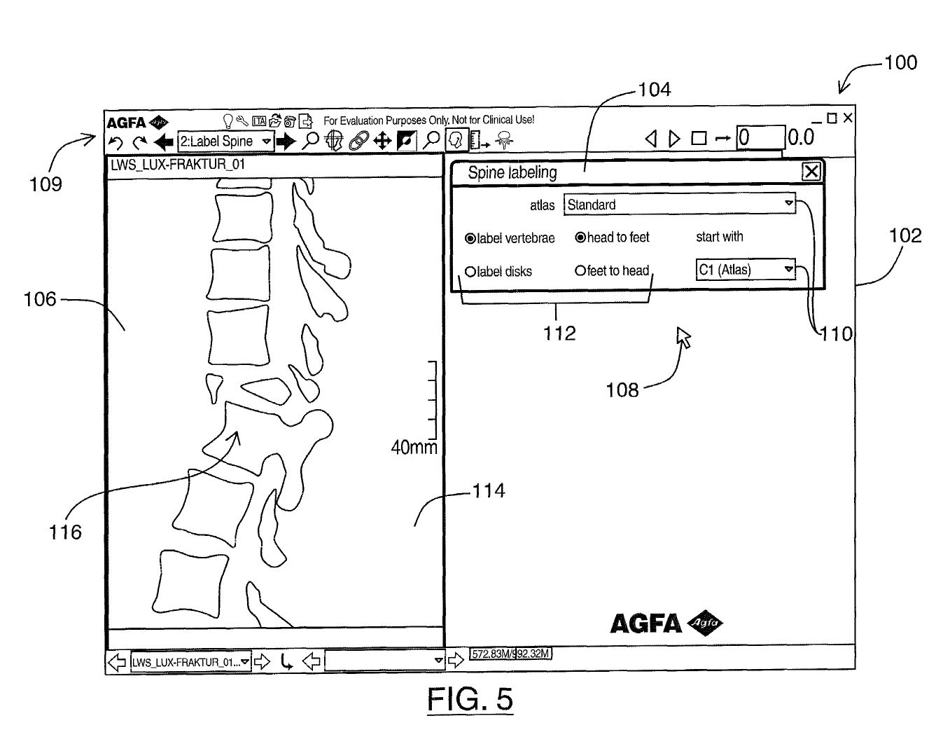

The image processing module 12 also instructs the geometric annotation module 18 to dynamically generate a geometric annotation interface (GAI) as discussed in more detail below with respect to FIG. 5. The GAI allows the user 11 to provide geometric annotations within the image block comprising one or more image series 30.

The series launching module 14 allows the user 11 to explicitly request a particular display configuration for the image series 30 from the study list 32, as is known in the art. The user 11 may also establish default configuration preferences to be stored in the user preference database 52, which would be utilized in the case where no explicit selection of display configuration is made by the user 11. The series launching module 14 also provides for the ability to establish system-wide or multi-user (i.e. departmental) configuration defaults to be used when no explicit initial configuration is selected on launch and when no user default has been established. Also, it should be understood that it is contemplated that the series launching module 14 can monitor the initial configuration selected by the user 11 or a group of users 11 in previous imaging sessions and store related preferences in the user preference database 52. Accordingly, when an image series 30 is launched, configuration preferences established in a previous session can be utilized. As discussed above, the view generation module 16 receives image data that corresponds to the image series 30 from the series launching module 14.

It will be appreciated by those skilled in the art that different medical practitioner users will use the geometric annotation system 10 for different functions. For example, a medical technician may be primarily responsible for annotation of the geospatial image data, and thus may primarily use the non-diagnostic interface 34 and user workstation 36. Conversely, a doctor may be primarily responsible for analyzing the geospatial image data using the annotations provided by the medical technician, and thus may primarily only use the diagnostic interface 28, and not interface directly with the user workstation 36.

Turning now to FIG. 3, an image block 50 for use with the geometric annotation system 10 is shown having at least one associated image series 30. The image series 30 comprises a plurality of individual images 54, such as a first image 54a, a second image 54b, a third image 54c and a final image 54z. The image block 50 is a three dimensional representation of the geospatial image data collected from a particular patient. In order to link the various images series 30 within a particular image block 50, a three-space Patient Coordinate System (PCS) is defined within the image block 50, as is generally known in the art. Each study list 32 and image series 30 associated or linked to the image block 50 is referenced to the PCS so that relative positions of the various images 54 or “slices” within the various image series 30 can be determined. This is true even when the various image series 30 are orthogonal to one another, and define a plurality of axial, sagittal and coronal images, as is often the case.

In some embodiments, each particular image 54 within an image series 30 contains corresponding positioning information about its relative position within the PCS. For example, as the modality 20 records individual images 54 or “slices” of a patient at various distances, each image 54 can be imprinted with location information generated by the modality 20 to allow the image 54 to be properly located within the particular PCS with respect to the other images 54 collected.

For example, consider a PCS defined in FIG. 3 and having referencing axes 58 located at an origin point P_{(0,0,0)}. According to one convention for a PCS, as described in the DICOM standard, the x-axis increases towards the left hand of the patient, the y-axis increases towards the posterior of the patient, and the z-axis increases towards the head of the patient.

According to this convention, the X-Z plane represents the coronal plane, the X-Y plane represents the axial plane, and the Y-Z plane represents the sagittal plane. Using this convention, the images 54 of image series 30 are all coronal images. Thus, as shown, the first image 54a is a coronal image bounded by points P_{(0,0,0)}, P_{(a,0,0)}, P_{(0,0,c)} and P_{(a,0,c)} within the PCS, while the last image 54z is a coronal image bounded by P_{(0,b,0)}, P_{(a,b,0)}, P_{(0,b,c)} and P_{(a,b,c)}. This image series 30 thus occupies a volume having a width “a”, a height “b” and a depth “c”, and each particular image 54 of image series 30 will contain data about its position within this volume.

Similarly, if the image block 50 contained a second image series having an axial planar orientation (as shown, in the X-Y plane), each particular image in the second image series could be cross-referenced to the first image series 30 by referencing the same PCS. In this manner, multiple images series can be combined to generate an image block 50 comprising geospatial patient image data in a number of planes.

Each image 54 in FIG. 3 is offset a distance “D” from the subsequent or preceding images, along the y-direction. It is generally the case that “D” is similar between particular images 54 in an image series 30, although this need not be the case, and “D” can certainly, and often does, vary greatly when moving between different image series 30.

As well known in the art, the image block 50 is a digital representation of actual physical observations made by using the modality 20 to scan a particular patient. For example, the image block 50 may correspond to a scan of an actual patient where the scan size had a width of 10 cm, a height of 10 cm and a depth of 1.6 cm. In such a case, the values “a” and “b” in FIG. 3 would each correspond to a “real-world” dimension of 10 cm, while the value “c” would represent a “real-world” value of 1.6 cm. In such a scenario, as sixteen particular images 54 are shown, the value “D” would correspond to a “real-world” value of 0.1 cm, meaning that each particular image 54 or “slice” was taken at a distance of 0.1 cm (or 1 mm) from the preceding slice.

The image series 30 comprises a plurality of images 54 representing image data at various three dimensional locations within the PCS Because three-dimensional images cannot be easily displayed using two dimensional interfaces (such as the non-diagnostic interface 34 or the diagnostic interface 28), typically only a subset of images, such as a single display image 56, is actively shown to the user 11 via a display device at any given time. The rest of the images 54 of the image series 30 remain hidden from view. When the user 11 desires to view a different portion of the image series 30, the user 11 selects one or more different images 54 to be displayed as the display image 56, as is known in the art. In this manner the user 11 can selectively view the entirety of the image series 30 using only a two-dimensional display screen.

It will of course be appreciated by those skilled in the art that it is possible and indeed common to display more than one display images 56 simultaneously on a single display or combination of displays by providing a plurality of viewing windows.

It will also be understood that image block 50 can comprise multiple image series 30 and multiple study lists 32, and generally defines a set of geospatial patient data within three space.

In some embodiments, the image block 50 does not include discrete images (such as particular images 54) or even an image series 30, and simply includes three dimensional geospatial patient image data represented as a surface model or a solid model. For example, if an exterior surface of a patient face were scanned to generate a surface model of the face, no discrete images would be provided; rather, a continuous or semi-continuous surface model would be provided. Similarly, three-dimensional volumetric models could be provided, either as scanned directly from a patient, or generated from one or more existing image series, for example by providing a rendered model generated from an image series 30.

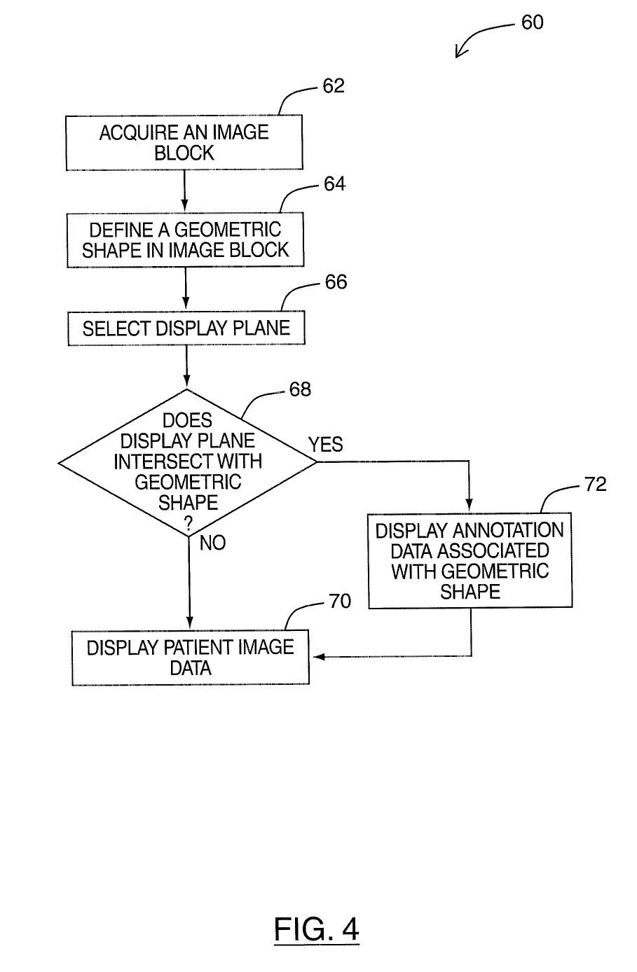

Turning now to FIG. 4, a method 60 of using the geometric annotation system 10 to annotate image data according to an embodiment is described. As will be understood, certain parts of the method 60 can be performed by the user 11 using the user workstation 36, while other parts will be performed automatically by the geometric annotation system 10.

At step (62), the geometric annotation system 10 acquires geospatial image data, such as image block 50 having image series 30. The image block 50 is preferably acquired from a storage location, such as the image database 24 on the image server 26. It is preferable in some embodiments that, once the image block 50 has been acquired, it is then displayed to the user 11 using the non-diagnostic interface 34.

At step (64), at least one geometric shape is associated with a particular location within the image block 50. The at least one geometric shape can be associated with the image block 50 in any number of ways. For example, an annotation plane comprising image data (such as display image 56 of the image series 30) can be defined and displayed to the user 11 allowing the user 11 to select a reference or markup point within the display image 56. For example, in the image block 50 shown in FIG. 3, a markup point can be defined at a point M_{(i,j,k)} on the display image 56 where 0≦i≦a, 0≦j≦b, and 0≦k≦c. In other embodiments, the user 11 may simply enter a point in three space using a keyboard or other data entry tool. Such embodiments may be desirable where the user 11 desires to accurately place a markup point on a plane that is not located on a particular discrete image 54 within the image series 30.

Once the markup point has been defined, a corresponding geometric shape is then associated. The geometric shape can be any suitable shape as selected by the user 11 or determined according to a particular application, and may have only one dimension (a point), two dimensions (a line), or three dimension (such as a sphere, cylinder, obround or other arbitrarily shaped object, such as an irregular object resulting from an object segmentation algorithm).

At step (66), the user 11 (who may be the same user as in steps (62) and (64) above, or a different user) selects a display plane within the image block 50 to be displayed using a display screen, such as the diagnostic interface 28 or the non-diagnostic interface 34. It will be appreciated by those skilled in the art that the display plane represents a plane or section of a plane within the image block 50 and may have any planar orientation, for example axial, coronal, sagittal, oblique and double oblique. Furtheremore, the display plane may be selected from a different image series 30 or study list 32, provided that the image series 30 or study list 32 is linked to the image block 50 by a common PCS.

At step (68), a determination is made as to whether the display plane selected at step (66) intersects with the geometric shape associated with the image block at step (64). This determination is done according to methods known in the art, and is a relatively simple process when the geometric shapes are simple, such as points, lines, and spheres, although this determination becomes increasingly more complex as the complexity of the geometric shape increases.

In some embodiments, when the geometric shape is parallel to the two most adjacent images and is located between them, the two dimensional geometric shape can be considered to have a minimal thickness, such as the distance between the two most adjacent images to ensure that the geometric shape intersects with the two most adjacent images, and that the corresponding annotation is displayed.

If, at step (68), a determination is made that the geometric shape and the display plane do not intersect, then any patient image data associated with the display plane selected at step (64) is displayed to the user 11 at step (70), without any additional information.

If, however, at step (68), a determination is made that the geometric shape does intersect with the display plane, then annotation information associated with the geometric shape is displayed to the user 11 at step (72), along with the patient image data associated with the display plane at step (70). For example, if the display plane shows patient image data having patient vertebrae data, and the intersected geometric shape contains annotation information explaining that this is the “T3” vertebra, this information is displayed to the user 11 via a display screen such as diagnostic interface 28.

It will be understood that the geometric shapes associated at step (64) are generally hidden from the display step (70). In this manner, the user 11 can associate geometric shapes with particular anatomical features of geospatial image data, such as in an image block 50, and display annotation information about those particular features as the user 11 navigates to various display planes within the image block 50. It will be appreciated by those skilled in the art that a plurality of geometric shapes can be associated within a particular image block 50, and further details are provided below with reference to the additional figures

Turning now to FIG. 5, a geometric annotation interface (GAI) 100 for implementing the geometric annotation system 10 is provided. The GAI 100 is generated by the geometric annotation module 18 as described above, and preferably includes a graphical user interface (GUI) window 102 shown on any display screen such as the diagnostic interface 28 or the non diagnostic interface 34. The GUI window 102 includes a number of elements for communicating information to the user 11 and for allowing the user 11 to input data into the geometric annotation system 10, including a menu dialog 104, an image window 106 (corresponding to the image area 44 described above) and a cursor 108. Various other window elements may also be present within the GUI window 102, such as menu items 109, and may include series header 43, or other control elements as known in the art, such as elements for closing or minimizing the GUI window 102, or moving the GUI window 102 within the display screen.

The menu dialog 104 may include a number different menu options, for example drop down lists 110, radio buttons 112, and other menu elements such as checkboxes and data entry boxes not shown but well known in the art. The menu dialog 104, drop down lists 110 and radio buttons 112 allow the user 11 to configure the GAI 100 of the geometric annotation system 10 for use with a particular image block 50 or image series 30.

The cursor 108 shown in FIG. 5 is manipulated by the user 11 using the user-pointing device 40, (e.g. the mouse, trackball or other device), and is used to select elements of the menu dialog 104 and manipulate the image 114 displayed in the image window 106.

For example, as shown in FIG. 5, when GAI 100 is to be used with an image series 30 containing patient spine data, the menu dialog 104 may be configured to implement a spine labeling module (SLM), wherein the radio buttons 112 allow the user 11 to select which order a spine is to be labeled (from head-to-feet or from feet-to-head), allow the user to select which anatomical features of the spine are to be labeled (such as the vertebrae or the inter-vertebral discs), and the drop down lists 110 may allow the user to select which particular anatomical feature will be selected first to begin the labeling process (such as the “C1 (Atlas)” vertebra) or whether to use a standard or other atlas for labeling. In some embodiments, elements of the menu dialog 104 may allow a user to select different geometrical shapes, such as spheres, cylinders or irregular geometrical shapes, for association with different anatomical features during an annotation or markup process.

When an image series 30 of image block 50 has been loaded by the geometric annotation system 10 using the image processing module 12, the image window 106 displays at least one image 114 of the image series 30. In FIG. 5, the image 114 shows a sagittal view of a patient's spine 116, and corresponds to the particular image 56 shown within a particular image series 30 of an image block.

It will be appreciated by those skilled in the art that in some embodiments it may be desirable to provide a plurality of image windows 106 for displaying a plurality of images 114 within a particular GUI window 102. In particular, it may be advantageous to include at least three image windows 106 to display axial, sagittal and coronal views of image data from the image series 30 or a plurality of image series 30. It may also be advantageous to display a fourth image window 106 providing a perspective view of a three-dimensional rendering of geospatial image data, or displaying an oblique view of image block 50.

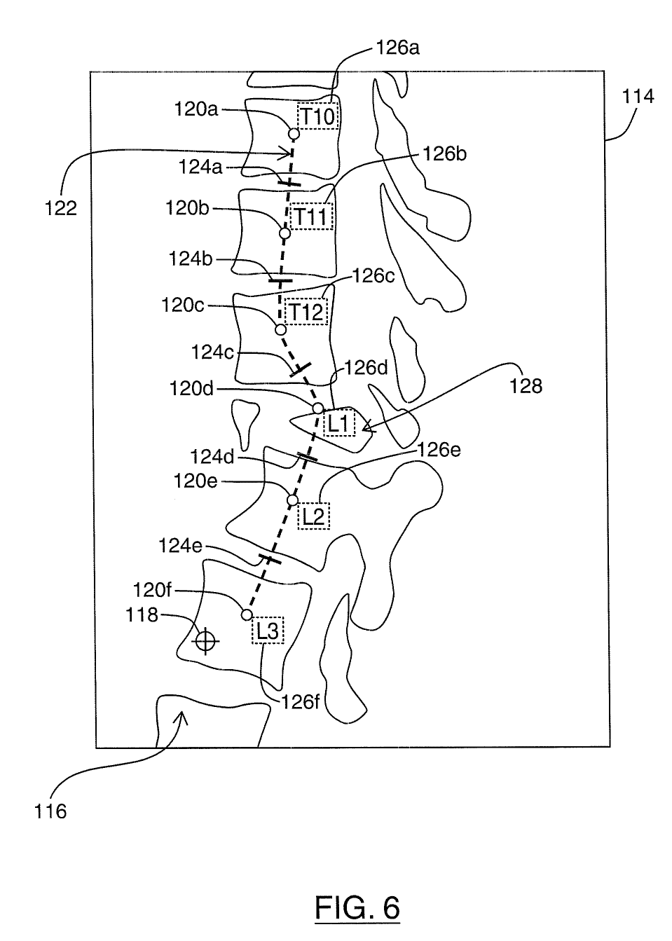

Turning now to FIG. 6, the user 11 is using the geometric annotation system 10 to implement a SLM and provide geometric annotation within the sagittal image 114 of spine 116 from FIG. 5. The user 11 has activated a “markup mode” by selecting a particular menu item 109 (FIG. 5), and the cursor 108 has been transformed into a markup cursor 118. Markup cursor 118 is also manipulated by the user pointing device 40, and is used to associate geometric annotation information within the image block 50 by selecting reference points, or markup points, within the sagittal image 114.

In this particular embodiment, the user 11 has engaged a SLM to annotate portions of the spine 116. The user 11 has placed markup points 120 (specifically markup points 120a, 120b, 120c, 120d, 120e and 120f) within the image 114 at the approximate center of the various vertebrae of the spine 116 shown in the image 114. The markup points 120 are joined by a guide spline 122 that passes though the markup points 120 and approximates the center of the spine 116 to assist the user 11 during the markup process.

In between successive markup points 120 are a series of midpoint indicators 124 (specifically midpoint indicators 124a, 124b, 124c, 124d, and 124e). For example, located between the markup points 120a and 120b is the midpoint indicator 124a. Each midpoint indicator 124 is located approximately halfway in between a pair successive markup points 120. In the SLM, the midpoint indicators 124 represents the approximate location of the inter-vertebral discs between any successive pair of vertebrae. In some embodiments the position of the midpoint indicators 124 can be adjusted by the user 11 or according to some other algorithm to better approximate the location of the discs.

As shown in FIG. 6, each markup point 120 has an associated markup tag 126 (specifically markup tags 126a, 126b, 126c, 126d, 126e, and 126f) that displays annotation information about the anatomical feature associated with the corresponding markup point 120. Using the SLM as shown in FIG. 6, the markup tags 126 provide the appropriate name for a particular vertebra. For example, the markup point 120a has an associated markup tag 126a that displays “T10” as a reference to the “thoracic 10” vertebra.

In some embodiments, the user 11 must manually enter the annotation data to be displayed by a particular markup tag 126. In other embodiments, such as in some embodiments of the SLM, the markup tags 126 contain pre-generated information, and may be selected by the user 11 or defined by the menu dialog 104. In some embodiments, when the user 11 engages the SLM, the user 11 is prompted with a pre-selected list of vertebrae to be labeled on the spine 116, and as the user 11 places a markup point 120 corresponding to a particular vertebra, the markup tag 126 associated with that vertebra is automatically generated and then the user 11 is prompted to enter the next vertebra in a sequence.

As shown in FIG. 6, spine 116 has a break of the first lumber vertebrae 128, which has resulted in an unnatural curvature of the spine 116 in both the sagittal and coronal planes as will be discussed in more detail below. It will be appreciated by those skilled in the art that, when image 114 is being displayed on a display screen such as diagnosis interface 28, and markup mode is disengaged, it may be preferable to hide all or a portion of the markup points 120, spline 122 and midpoint indicators 124, and that generally only the markup tags 126 are displayed. This is done to avoid cluttering the image 114, and provide for an improved user experience.

In some embodiments, the user 11 can select whether he wants to label the vertebrae or the intervertebral discs, and during the annotation process geometric shapes and corresponding annotation information can be automatically associated with both the vertebrae and intervertebral discs. For example, the user 11 could manually locate geometric shapes on several vertebrae, while the geometric annotation system 10 would automatically generate geometric shapes representing the intervertebral discs. In some such embodiments, the annotation information for both the vertebrae and the intervertebral discs could be displayed concurrently. In other embodiments, only one set of annotation information would be displayed, and the user 11 could switch between annotation information for the vertebrae and the intervertebral discs as desired.

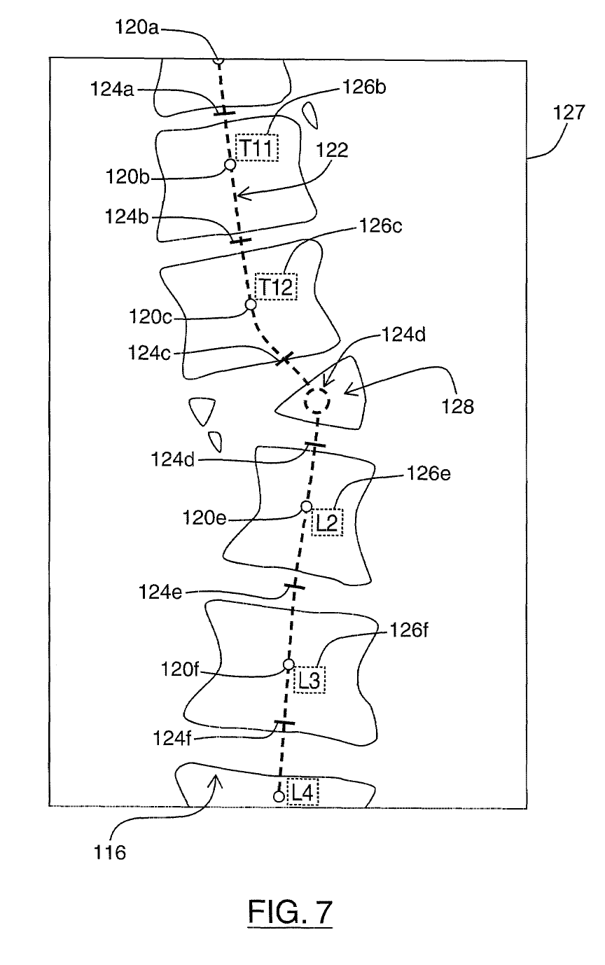

Turning now to FIG. 7, a coronal view of the same spine 116 is shown in coronal spine image 127 displayed in image window 106 (FIG. 5). Coronal spine image 126 is a second particular image in a second image series (not shown) associated with the same image block 50. As evident from FIG. 7, the markup tags 126 of the SLM are shown regardless of the particular orientation of the display plane. What matters is whether the particular geometric shape associated with the markup points 120 is being intersected by the displayed image.

As the user 11 adds various markup points 120 to define geometric annotations in the image series 30, the user 11 can switch between various image planes, such as a sagittal plane or coronal plane of the image block 50, by switching between the first image series 30 and the second image series. The user 11 can also cycle between various particular images 54 within the first image series 30 and second image series to view the spine 116 using different planar orientations to properly position the markup points 120 within the three-dimensional space defined by the PCS. Thus, the user 11 will be able to accurately mark the various vertebrae of the spine 116 and easily change planar orientations and position within the PCS to accommodate features including spine curvature, such as for a patient suffering from scoliosis. In some embodiments, the user 11 is permitted to switch views during the markup process while placing markup points 120 within an image block. In other embodiments, the user 11 places the markup points 120 within one image series 30 or within one particular image 54 of an image series 30, and then edits the markup points 120 to correct their alignment within the image block 50 by switching between different images series 30.

For example, spine 116 as shown in FIGS. 6 and 7 has a break of the first lumbar vertebra 128. This has caused a curvature of the spine 116 in both the sagittal plane (as shown in FIG. 6), and the coronal plane (as shown in FIG. 7). As the user 11 attempts to properly position the markup point 124d at the first lumbar vertebra 128 of the spine 116, the user 11 can cycle between sagittal spine images 114 and coronal spine images 126 to properly align the markup points 124d.

Markup tags 126 and the associated markup points 120 are only displayed within any particular display image, such as coronal spine image 126, when the geometric shape associated with a particular markup point 120 is intersected by the display plane. For example, in one embodiment shown in in FIG. 7, each markup point 120 has an associated geometric shape having one dimension, namely a “point”, located at the centre of each markup point 120. In FIG. 7, markup points 120a, 120b, 120c, 120e and 120f are each displayed, along with their corresponding markup tags 126a, 126b, 126c, 126e and 126f, because those markup points 120 have been positioned to fall on the plane defined by FIG. 7. However, the markup point 120d lies on a different plane, and is thus not intersected by the display plane shown in FIG. 7. Thus, markup point 120d is not shown (or here is shown using hidden lines, to indicate that it lies on a different plane) and markup tag 126d is similarly not displayed.

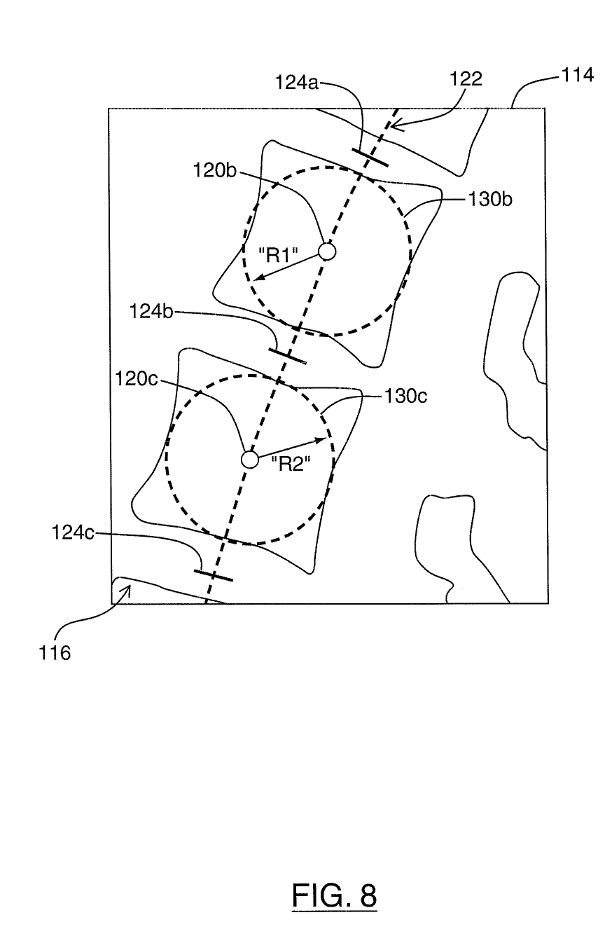

Turning now to FIG. 8, a close-up of sagittal spine image 114 is provided where the geometric shapes associated with each markup point 120 are spheres 130 as opposed to the points used in FIG. 7. In particular, spheres 130b, and 130c, and are centered around markup points 120b and 120c, respectively. In some embodiments, the size of each sphere 130 is proportional to the distance between two successive markup points 120. In other embodiments, the spheres 130 can be sized according to the distance between a markup point 120 and a subsequent midpoint indicator 124. For example, sphere 130b can be defined to have a centre at markup point 120b, and a radius of “R1” equal to 90% of the distance between centre of sphere 130b (the markup point 120b) and the midpoint indicator 124b. Similarly, the sphere 130c can be defined to have a center at markup point 120c and a radius “R2” equal to 90% of the distance between the markup point 120c and the midpoint indicator 124c. It will thus be appreciated that “R1” and “R2” need not generally be equal.

In some other embodiments, the size of the spheres may be a function of the distance between a particular markup point 120, such as the markup point 120c and two closest midpoint indicators 124, such as midpoint indicators 124b and 124c. In yet other embodiments, the size of each sphere 130 can be pre-selected by the user 11, or can be adjusted by the user 11 once a particular markup point 120 has been placed. In some other embodiments, the spheres 130 are pre-sized according to defined parameters within the geometric annotation system 10, and may be based on a particular anatomical annotation module being engaged, such as the SLM.

In some embodiments, the position of each markup point 120 can be adjusted once placed to provide the user 11 with the ability to edit the location of the spheres 130. It will be appreciated by those skilled in the art that various ways of defining the size and location of the spheres 130 can be provided to approximate the sizes of the various vertebrae being annotated using markup points 120.

In some embodiments, the radii of one or more of the spheres 130 could be determined by some automated segmentation methods. In other embodiments, automatic segmentation could be used to determine the centre point of the sphere, or could be used to re-position the centre of the sphere within the centre of the vertebrae.

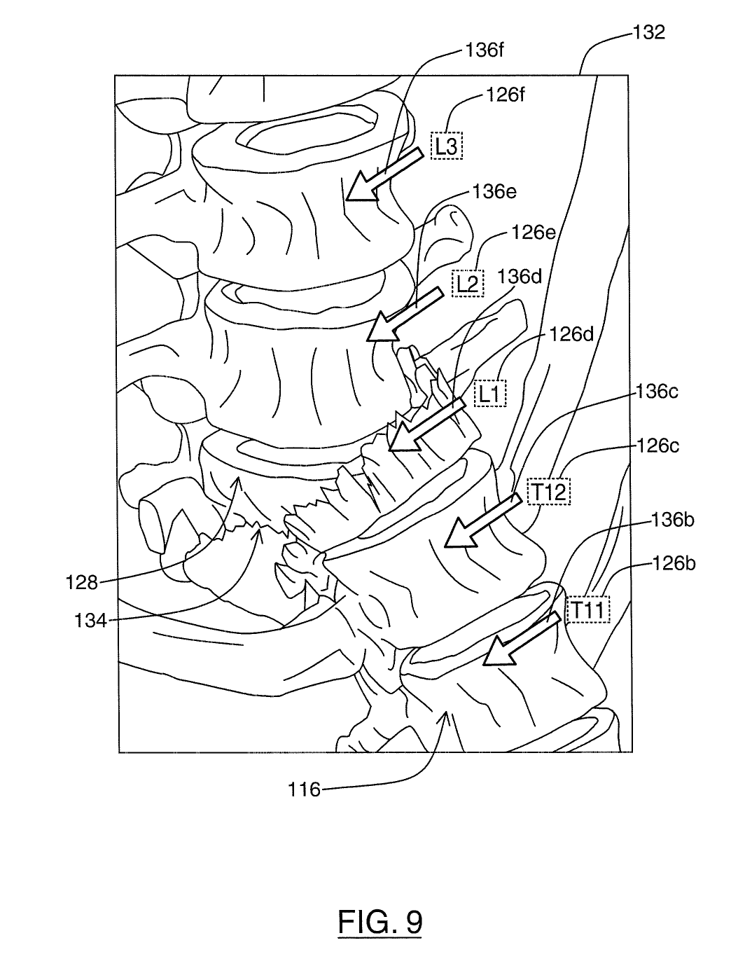

Turning now to FIG. 9, the spine 116 is shown as a rendered, three-dimensional image 132. In this view, the break at the first lumbar vertebrae 128 is visible along break edge 134, as is the curvature of the spine 116 in both the sagittal and coronal planes. The markup tags 126 are also shown, along with markup arrows 136 that are pointing the particular anatomical features associated with the markup tags and geometric shapes (hidden from view in FIG. 9). In particular, markup arrows 136b, 136c, 136d, 136e and 136f are pointing to the “T11”, “T12”, “L1”, “L2” and “L3” vertebrae, respectively. For example, markup tag 126d is associated with markup arrow 136d, which points to the first lumbar vertebrae 128.

In this rendered, three-dimensional image 132, the user 11 can optionally rotate the spine 116 to view the spine 116 from various viewing angles and planes, and the markup tags 126 and markup arrows 136 will remain pointing to the correct vertebrae to provide the user 11 with an accurate geometric annotation information that is independent of viewing angle.

As discussed above, in some embodiments, the image block 50 may consist only of a rendered three-dimensional representation of patient image data, such as this rendered, three-dimensional image 132, wherein discrete images 54 within the image block 50 are not provided. In such embodiments, geometric annotation information could be associated within the image block 50 by manipulating the rendered, three-dimensional image 132 shown in FIG. 9.

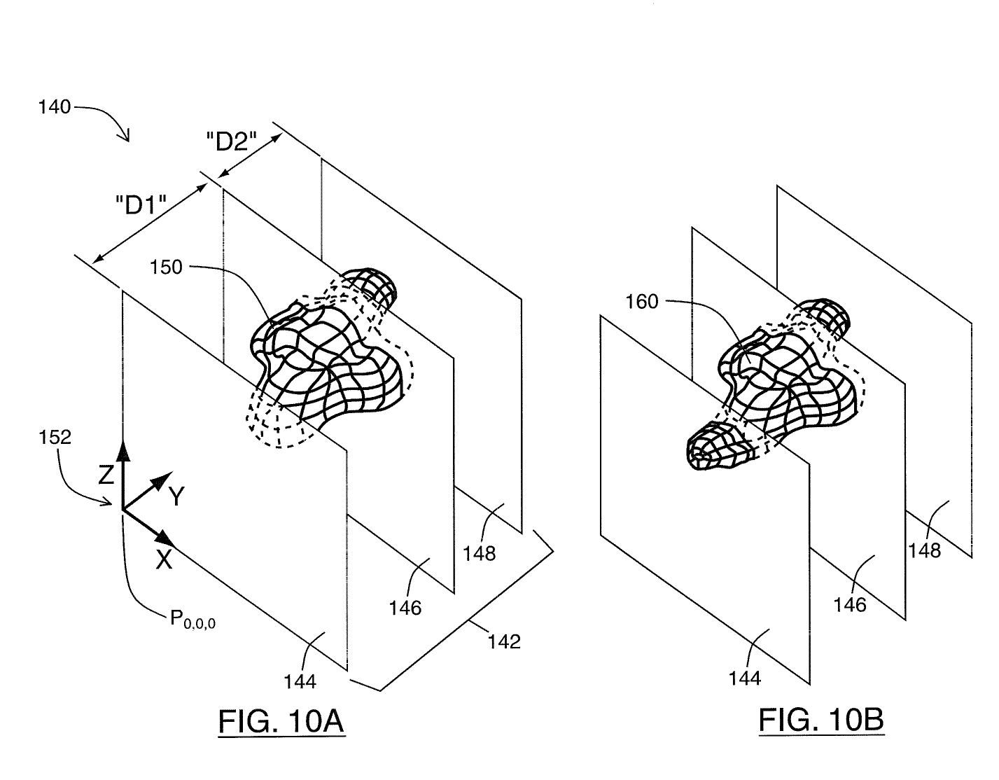

In some embodiments, irregular geometric shapes may be used to provide geometric annotation. For example, FIG. 10A provides an example of an image block 140 having a coronal image series 142 comprising three images, a first image 144, a second image 146 and a third image 148. The image block 140 has a three-dimensional irregular shape 150 associated within it. Irregular shape 150 will preferably have annotation data associated with it (not shown for clarity).

Reference axes 152 are shown at the origin, P(0,0,0) and a PCS is defined within the image block 140. The first image 144 and second image 146 are separated by a first distance of “D1”, and the second image 146 and third image 148 are separated by a second distance of “D2”, which is not necessarily equal to “D1”.

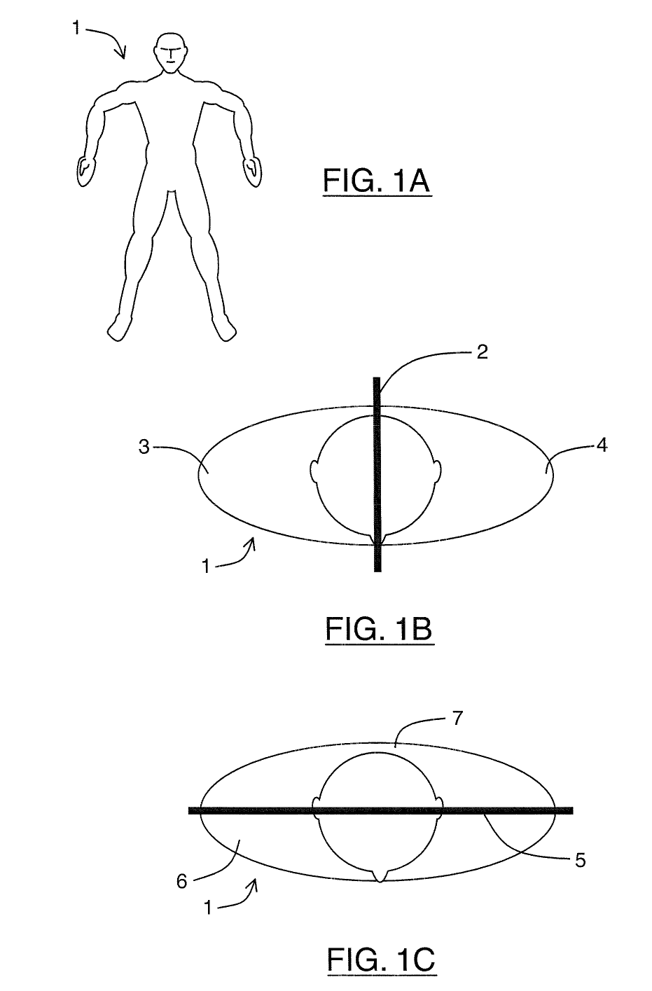

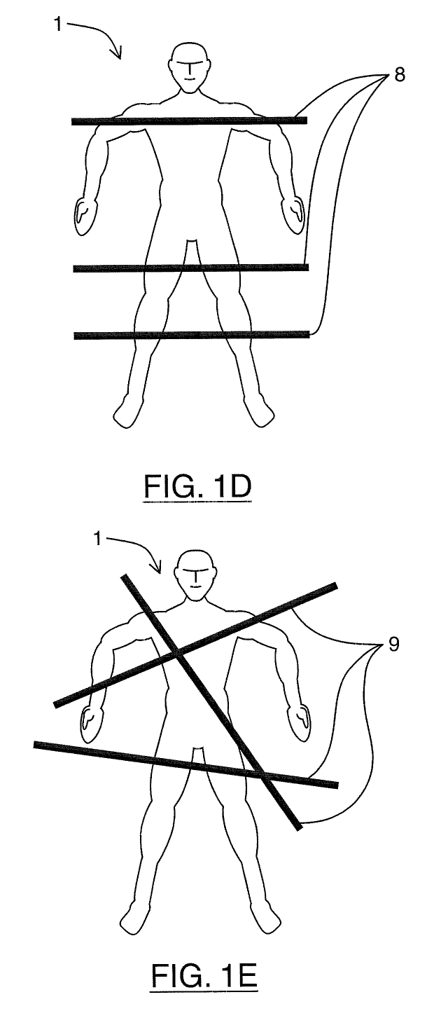

As shown in FIG. 1A, the irregular shape 150 is shown intersected with the second image 146, but does not intersect with the first image 144 or the third image 148. Thus, when the second image 146 is displayed on a display screen, such as the diagnostic interface 28, any annotation information associated with the irregular shape 150 will be displayed. However, when either the first image 144 or third image 148 are displayed on display screen, no annotation information associated with the irregular shape 150 will be displayed.

FIG. 10B shows an alternative result, where a second irregular shape 160 is defined within the same image block 140, and intersects with the first image 144 and the second image 146. Here, when either the first image 144 or second image 146 are displayed, any annotation information that is associated with the second irregular shape 160 will also be displayed on the display screen.

Geometric shapes such as the irregular shape 150 can be generated using various different methods. In some embodiments, the user 11 can select a particular irregular shape from an atlas or library of irregular shapes corresponding to particular anatomical features, such as vertebrae and other bones, organs or tissues. In such embodiments, the user 11 may be able to scale or otherwise adjust the particular irregular shapes, to provide better conformity to the particular anatomical feature being modeled.

In other embodiments, irregular geometric shapes can be generated automatically by the geometric annotation system 10 based on particular contrast levels of image data within an image block 50. In some such embodiments, predefined threshold levels can be selected to allow the geometric annotation system 10 to perform a process akin to volume rendering, automatically generating geometric shapes within the image block 50. In other such embodiments, any segmentation algorithm that automatically or semi-automatically segments an object within the three dimensional volume can be used.

While the various exemplary embodiments of the geometric annotation system 10 have been described in the context of medical image management in order to provide an application-specific illustration, it should be understood that the geometric annotation system 10 could also be adapted to any other type of image or document display system.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. A method of geometrical annotation, comprising:
(a) acquiring an image block having geospatial image data;
(b) defining, within the image block, at least one geometric shape having associated annotation data;
(c) selecting, within the image block at least one display plane;
(d) determining if the at least one display plane intersects with the at least one geometric shape;
(e) displaying geospatial image data associated with the at least one display plane; and
(f) for each display plane where (d) is true, displaying the annotation data associated with the at least one geometric shape being intersected by that display plane.

2. The method of claim 1, wherein the image block comprises a first image series having a first plurality of images, the first plurality of images being spaced apart and parallel to a first reference plane.

3. The method of claim 2, wherein the image block comprises a second image series having a second plurality of images, the second plurality of images being spaced apart and parallel to a second reference plane, wherein the second reference plane is orthogonal to the first reference plane.

4. The method of claim 3, wherein the image block comprises a third image series having a third plurality of images, the third plurality of images being spaced apart and parallel to a third reference plane, and wherein the third reference plane is orthogonal to the second reference plane and the first reference plane.

5. The method of claim 4, wherein the geospatial image data comprises geospatial patient image data.

6. The method of claim 1, wherein the at least one geometric shape is defined by:
(g) selecting within the image block at least one annotation plane;
(h) displaying the at least one annotation plane;
(i) selecting, within the at least one annotation plane, at least one reference point; and
(j) associating the at least one geometric shape with the at least one reference point.

7. The method of claim 6, wherein the at least one geometric shape has at least two dimensions.

8. The method of claim 7, wherein the at least one geometric shape has three dimensions.

9. The method of claim 8, wherein the at least one geometric shape comprises a sphere.

10. The method of claim 8, wherein the geometric shape comprises a cylinder.

11. The method of claim 1, wherein the geometric shape comprises a geometric shape selected from an anatomical atlas having a plurality of pre-generated geometric shapes defined therein.

12. The method of claim 5, wherein the annotation data associated with the at least one geometric shape comprises anatomical data associated with the geospatial patient image data.

13. The method of claim 1, wherein the geometric shape is generated using a segmentation algorithm.

14. A computer-readable medium upon which a plurality of instructions are stored, the instructions for performing the steps of the method as claimed in claim 1.

15. A system for providing geometrical annotation to an image block, comprising:
(a) a database for storing the image block, wherein the image block comprises geospatial image data;
(b) a geometric annotation module configured to:
(i) define, within the image block, at least one geometric shape having associated annotation data,
(ii) select, within the image block at least one display plane, and
(iii) determine if the at least one display plane intersects with the at least one geometric shape; and
(c) at least one display being configured to display geospatial image data of the image block associated with the at least one display plane,
wherein the at least one display being further configured to display the annotation data associated with the at least one geometric shape for each display plane that intersects with the at least one geometric shape.

16. The system of claim 15, further comprising a user workstation configured to interface with the geometric annotation module for defining the at least one geometric shape within the image block, and for selecting the at least one display plane within the image block.

17. The system of claim 15, wherein the image block comprises a first image series having a first plurality of images, the first plurality of images being spaced apart and parallel to a first reference plane.

18. The system of claim 15, wherein the image block comprises a second image series having a second plurality of images, the second plurality of images being spaced apart and parallel to a second reference plane and wherein the second reference plane is orthogonal to the first reference plane.

19. The system of claim 15, wherein the at least one geometric shape is defined by:
(d) selecting within the image block at least one annotation plane;
(e) displaying the at least one annotation plane;
(f) selecting, within the at least one annotation plane, at least one reference point; and
(g) associating the at least one geometric shape with the at least one reference point.

20. The system of claim 15, wherein the at least one geometric shape has three dimensions.
